(19) United States
(12) Patent Application Publication
(10) Pub. No.: US 2015/0324460 A1
(43) Pub. Date: Nov. 12, 2015

(54) LONG TAIL MONETIZATION PROCEDURE FOR MUSIC INVENTORIES

(71) Applicant: R & R MUSIC LIMITED, Falkirk (GB)

(72) Inventor: Antonio Trias, Barcelona (ES)

(21) Appl. No.: 14/803,495

(22) Filed: Jul. 20, 2015

Related U.S. Application Data
(63) Continuation-in-part of application No. 13/561,379, filed on Jul. 30, 2012, now Pat. No. 9,087,307.
(60) Provisional application No. 61/512,657, filed on Jul. 28, 2011.

(51) Int. Cl. G06F 17/30; G06F 7/24

(52) U.S. Cl. CPC G06F 17/30772; G06F 17/30743; G06F 7/24; G06F 17/30761

(57) ABSTRACT

A system and method for constructively providing a monetization procedure for a long tail demand curve of market goods, services or contents in the music industry through a channel such as the Internet or mobile devices, for which there exists a source providing economic scoring (sales, downloads, streaming time, etc.). Using only the scorings for a few reference items and a quantitative concept of similarity between the songs, a procedure is provided that constructively distributes the preference score from the reference items to the non-ranked ones, yielding the full scoring curve adjusted to a long tail law (power law). In order to build preference scores for non-ranked items, the method recursively defines relative preferences between songs based on their similarity, thus constructing a utility-like function. The preferences are then used within an iterative Elo-like tournament strategy between the items.

### CROSS REFERENCE TO RELATED APPLICATIONS

The present application is a continuation-in-part of co-pending and co-owned U.S. patent application Ser. No. 13/561,379 entitled “LONG TAIL MONETIZATION PROCEDURE”, filed on Jul. 30, 2012, which claims the benefit of U.S. Patent Application Ser. No. 61/512,657 entitled “LONG TAIL MONETIZATION PROCEDURE”, filed on Jul. 28, 2011, the entire teachings of which are incorporated herein by reference.

### BACKGROUND

The present disclosure relates to the problem of modeling the scoring or demand curves for large sets of objects (products or downloads), in cases where the demand behavior is known to exhibit the Long Tail phenomenon. This is particularly relevant in the context of Internet-based commerce, where various businesses have been experimentally proven to behave that way. In particular, the method concentrates on the problem of predicting the full scoring curve using incomplete information. The method works with the score values of just a few (reference) objects, plus some quantified measure of similarity between all the objects.

The concept of a “long tail” distribution has been commonly used in diverse fields, such as statistics and physics, to refer to phenomena in which the distribution of a magnitude is shown to exhibit a power-law decay as the magnitude approaches very large values. For the purposes of this discussion, power-law decaying distributions are special mainly because of the much slower rate of decay as compared with Gaussian distributions, for example. However, power laws are also special because they show scale-free behavior, meaning that the shape of the curve can be easily rescaled to fit a common (i.e. “universal”) power law of the type x^{α}. In other words, the exponent a is all that characterizes the distribution curve for large x.

In the context of the Internet-based economy, the popularization of the concept of “The Long Tail” is, for most of the new big Internet retailers, based on the fact that the demand exhibits a power law behavior. Some examples cover particularly interesting ones with reference to Wal-Mart and Rhapsody music contents, and how the evolution along the years increases sales from larger catalogues and away from the first 100 popular songs into the long tail. Note that this actually concerns the demand curve for the universe of items on sale, when these are ordered by sales rank. Although it may be tempting to think of it as a “probability distribution” for the number of sales, this could be misleading and lead to wrong analyses. Notwithstanding a few criticisms, it is widely recognized that the tenets of the theory are experimentally confirmed both for large and small retailers.

The mechanisms by which the long tail behavior appears are well known: the new era of on-line retail allows businesses to enlarge their product catalog endlessly, because shelf-space costs are nearly zero. Once consumers are offered limitless variety, it is to be expected that the demand curves extend their shape to more and more items. However, the non-obvious aspect of the theory is that the particular shape of the tail is a power-law tail (see FIG. 1). The implications for business models are then clear: an Internet business can now monetize the tail of the long tail distribution of the demand. Moreover, the demand in the whole tail can actually add up to a percentage of sales that rivals the head of the curve (see FIG. 2). Today, it is evident that the most successful Internet businesses have been those with the vision and skills to monetize the long tail of the demand.

Therefore, it has become quite important to accurately model and predict the long tail part of a demand curve, in order to optimize the economic value extracted from it. Such modeling enables better quantification of targeted marketing or recommendation system efforts. Although the long tail framework is quite recent, many publications and innovations make use of it in one way or another.

### SUMMARY

The method disclosed herein addresses the construction of a demand curve a priori and the related problem of predicting the relative score of a new item in the universe of items. One source of inspiration comes from the well-known utility function theorem described in Von Neumann et al., “Theory of Games and Economic Behavior”, Third Ed. (Princeton University Press, 1953), which asserts that there exists a function that is able to reproduce the outcomes of a set of pair-wise preferences between the items in the set. The other comes from the Elo rating system for ranking chess players, a process by which the relative skills between players end up producing a scoring curve that approximates the expected distribution (a Gaussian in this case). Invented by the Hungarian-born American physicist and chess master Arpad Elo, the Elo method works by exchanging rating values between each two players according to the results of their match, using a precise formula designed to reproduce a Gaussian distribution. After a sufficiently large number of tournaments, the emergent curve of Elo ratings does reproduce the expected distribution. The Elo system was invented as an improved chess rating system, but today it is also used in many other multiplayer games and competitions. Even if statistical tests have shown that chess performance is not exactly normally distributed, the method is used with modified formulas, but still referred to as the Elo system.

Today, artists and websites on-line, such as iTunes and Amazon and other specialized distributors, sell new songs by individual song versus selling album by album, revolutionizing the industry. The Music MELO: MMELO method here introduced brings a method that will allow for monetizing the large inventory catalogues' current tails, as well as older ones brought to today's attention. The systems and methods herein also allow for monetizing for the small productions of independent artists making their music available on-line.

Most on-line discovery and delivery of music is not based on strong social networking where artists and other authorities use software methods that for various technical or commercial reasons only bring to the listener or user songs that are at the HEAD of the long tail power distribution of the music universe, the so called “HITS” or songs in well-known niches of specialized non-hit music. On-line music needs monetization as a success in order to survive and become profitable. When in the near future the songs listened to or downloaded are 90% within the TAIL of the power law distribution, the music democratization revolution will be in place.

A main objective of this monetization procedure for long tail businesses is to provide a constructive method for obtaining the full distribution of preference scores for music songs in a large inventory of recordings, using only partial information about a few songs as reference items (for which the preference score is known) and a quantitative method to express similarity between items. In other words, the method disclosed herein achieves an a priori modeling of the long-tailed demand curves using only partial information.

The system and method herein can constructively provide a monetization procedure for a long tail demand curve of market goods, which in this case are music song recordings, services that can be as wide as supervised (by the user, DJ's, Artists) or unsupervised recommendations (algorithmically based), hit prediction, discovery, or contents such as digital music songs in standard formats, through a channel such as the Internet or mobile devices, for which there exists a source providing economic scoring (sales, downloads, streaming time, etc.). Using only the scores for a few reference items and a quantitative concept of similarity between the items, the systems and methods herein provide a procedure that constructively distributes the preference score from the reference items to the non-ranked ones, yielding the full scoring curve adjusted to a long tail law (power law). In order to build preference scores for non-ranked items, the method recursively defines relative preferences between items based on their similarity, thus constructing a utility-like function. The preferences are then used within an iterative tournament strategy between the items, inspired in the Elo method employed in the rating of professional chess players. This preference score can then be used to determine a recommendation strategy for content delivery that will have similarity as the base factor, yet allow improvement and optimization of the monetization of the tail of the long tail distribution in a more controlled manner.

According to a method herein, a digital database comprising digital song files is provided. The digital song files are mathematically analyzed. Preference score values for at least one of the digital song files are determined. An ordered set of songs is selected from the database. The ordered set of songs includes a set of reference songs each having a corresponding known preference score value and another set of songs each not having a corresponding known preference score value. A first temporary preference score value of zero is assigned to each song of the another set of songs not having a corresponding known preference score value. A window of consecutive songs is selected from the ordered set of songs. The window includes a first subset of reference songs each having the corresponding known preference score value and a second subset of songs each having a corresponding preference score value of zero. A second temporary preference score value is calculated for each song of the second subset of songs in the window, based on similarity to a nearest song in the first subset of reference songs in order to generate a set of second temporary preference score values. The songs in the window are reordered based on the set of second temporary preference score values and the known preference score values of the first subset of reference songs.

According to a computer implemented method of determining monetization for a long tail demand curve, a demand curve comprising an ordered set of songs is provided. The ordered set of songs includes a set of reference songs each having a corresponding known preference score value and another set of songs each not having a corresponding known preference score value. A first window of consecutive songs is selected from the ordered set of songs. The first window includes a first subset of reference songs each having the corresponding known preference score value and a second subset of songs each not having a corresponding preference score value. The known preference score value is based on economic factors comprising one of sales, downloads, and streaming time. A temporary preference score value is calculated for each song of the second subset of songs in the first window, based on similarity to a nearest song in the first subset of reference songs in order to generate a set of temporary preference score values. The similarity measure could be based on a distance function such as the Euclidean distance between characteristic vectors for each song. All songs in the first window are reordered based on the set of temporary preference score values and the known preference score values of the first subset of reference songs. A new score value for each song in the first window is calculated using a power-law exponential equation. The calculating is performed by obtaining a score value to a boundary element and recursively calculating the corresponding new score for each song in the first window based on the score value of the boundary element and the corresponding temporary preference score value or the corresponding known preference score value of the song to generate a set of new score values of the first window. The boundary element is a song in the ordered set of songs outside of the first window.

According to a system, a digital database comprising digital song files is operatively connected to a processor, and a memory is operatively connected to the processor. The processor mathematically analyzes the digital song files and determines characteristic vectors for the songs in the digital song files. The processor selects an ordered set of songs from the database. The ordered set of songs includes a set of reference songs each having a corresponding known preference score value and another set of songs each not having a corresponding known preference score value. The known preference score value is based on economic factors comprising one of sales, downloads, and streaming time. The processor assigns a first temporary preference score value of zero to each song of the another set of songs not having a corresponding known preference score value. The processor selects a window of consecutive songs from the ordered set of songs. The window includes a first subset of reference songs each having the corresponding known preference score value and a second subset of songs each having a corresponding preference score value of zero. The processor calculates a second temporary preference score value for each song of the second subset of songs in the window, based on similarity to a nearest song in the first subset of reference songs in order to generate a set of second temporary preference score values. The similarity measure could be based on the Euclidean distance between the characteristic vectors for each song. The processor stores the second temporary preference score value in the memory. The processor reorders the songs in the window based on the set of second temporary preference score values and the known preference score values of the first subset of reference songs.

### BRIEF DESCRIPTION OF THE DRAWINGS

The systems and methods herein will be better understood from the following detailed description with reference to the drawings, which are not necessarily drawn to scale and in which:

FIG. 1 is an example of a basic long tail power law distribution function and graph;

FIG. 2 shows separation of the head and tail of the basic long tail power law distribution graph of FIG. 1;

FIG. 3 is a close-up view of the tail portion of the graph in FIG. 2;

FIG. 4 is a further amplified view of the tail portion of the graph in FIG. 3;

FIG. 5 is a further amplified view of the tail portion of the graph in FIG. 4;

FIG. 6 shows a comparison of the tail portions shown in FIGS. 3, 4, and 5;

FIG. 7 shows the basic input for a scoring procedure according to systems and methods herein;

FIG. 8 shows as example an instantiation with Music Songs of some of the components for the basic input fields of FIG. 7 according to systems and methods herein;

FIG. 9 illustrates establishing the ELO-like tournament a process step in a scoring procedure according to systems and methods herein;

FIG. 10 illustrates the process for handling by use of the predefined similarity measure to recursively construct preferences within the chosen window according to systems and methods herein;

FIG. 11 illustrates a process step in a scoring procedure using the neighborhoods of already scored songs according to systems and methods herein;

FIG. 12 illustrates a process step of reordering songs within the window chosen in a scoring procedure according to systems and methods herein;

FIG. 13 illustrates the process for handling similarity based recursive preferences assuring continuity according to systems and methods herein;

FIG. 14 illustrates a process step in a redefinition of the scoring of songs according to systems and methods herein;

FIG. 15 illustrates a process step in a scoring procedure using normalization according to systems and methods herein;

FIG. 16 is a flow diagram according to methods herein; and

FIG. 17 is a schematic diagram of a hardware system according to systems and methods herein.

### DETAILED DESCRIPTION

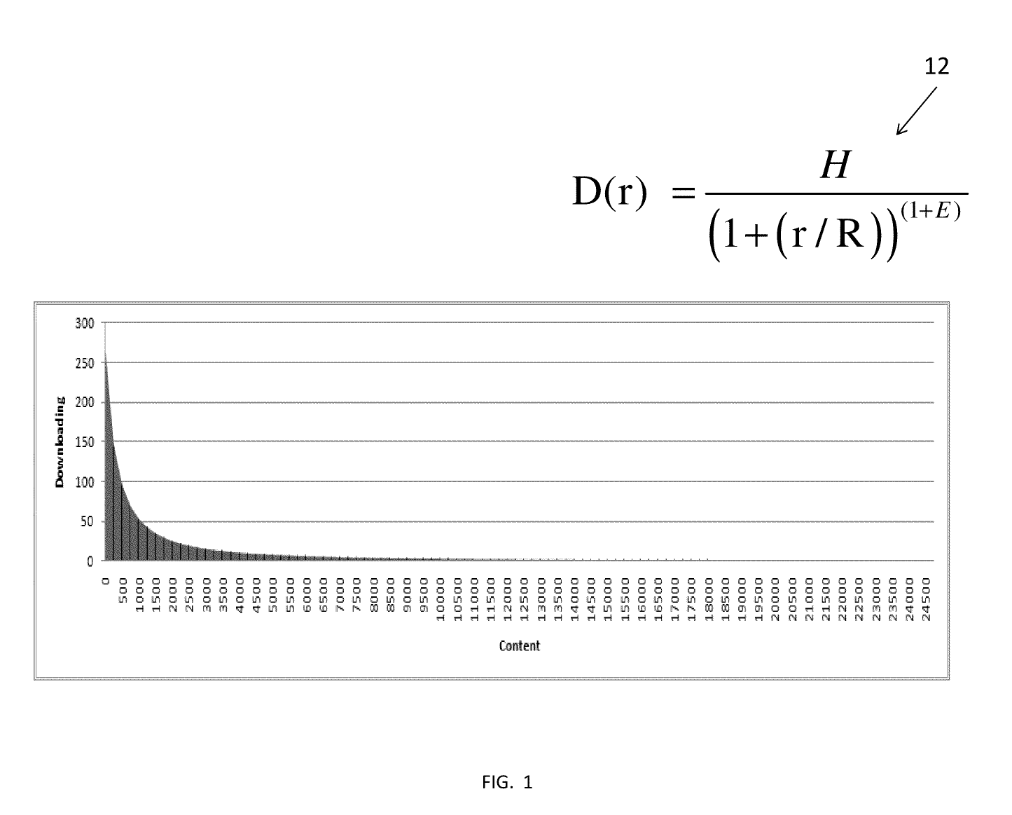

As popularized by the so-called Long Tail theory, the new era of on-line retail allows businesses to enlarge their product catalog endlessly, at nearly zero-cost. Once the full range of different products is made available to the people, it is an experimental fact that the demand curves exhibit a long tail shape, as shown in FIG. 1, whereby the demand for the lowest-ranked products does not fall sharply to zero (as it did in the pre-Internet era due to limited catalog offer, on the retailers part). The gist of the theory is that businesses can now monetize the long tail part of the demand. Moreover, the demand in the whole tail can actually add up to a percentage of sales that rivals the head of the curve.

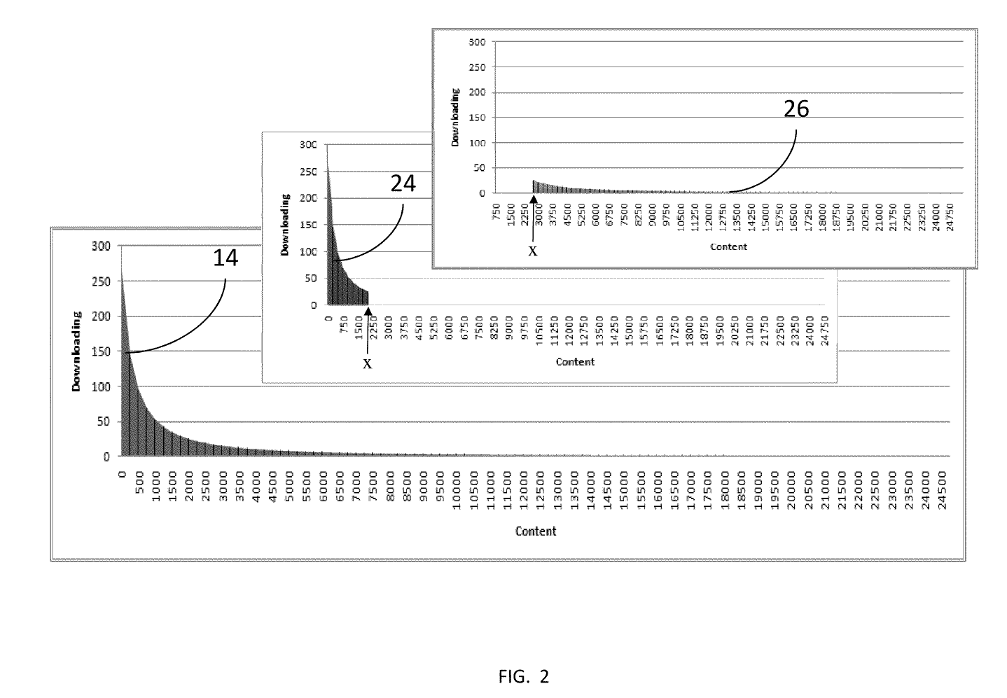

Referring to FIG. 1, for a given distribution, (such as by using a set of established parameters of the power law distribution as shown at 12) we depict the curve 14. FIG. 2 shows a separation of the curve 14 into two parts: head 24 and tail 26. In this manner, we can start to see the behavior of the head 24 and tail 26. We can arbitrarily choose, for the purpose of the example, the position of the value x separating the head 24 and tail 26. In the example shown in FIG. 2, we have used the value at x=1.9 thousand as the separation point, since it is the one that makes the areas under the curve (to the left and right of the x) equal.

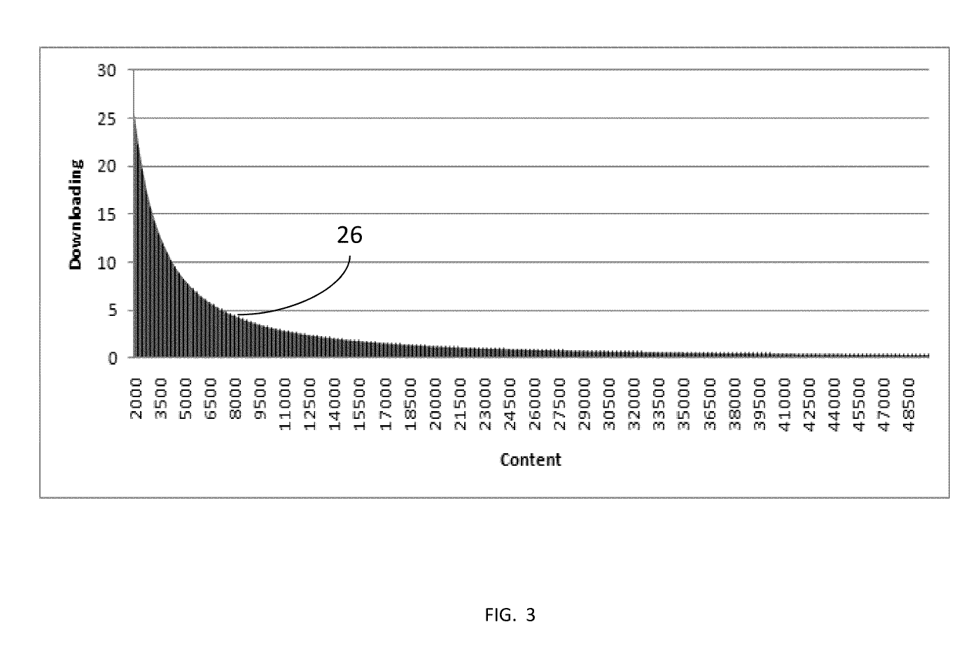

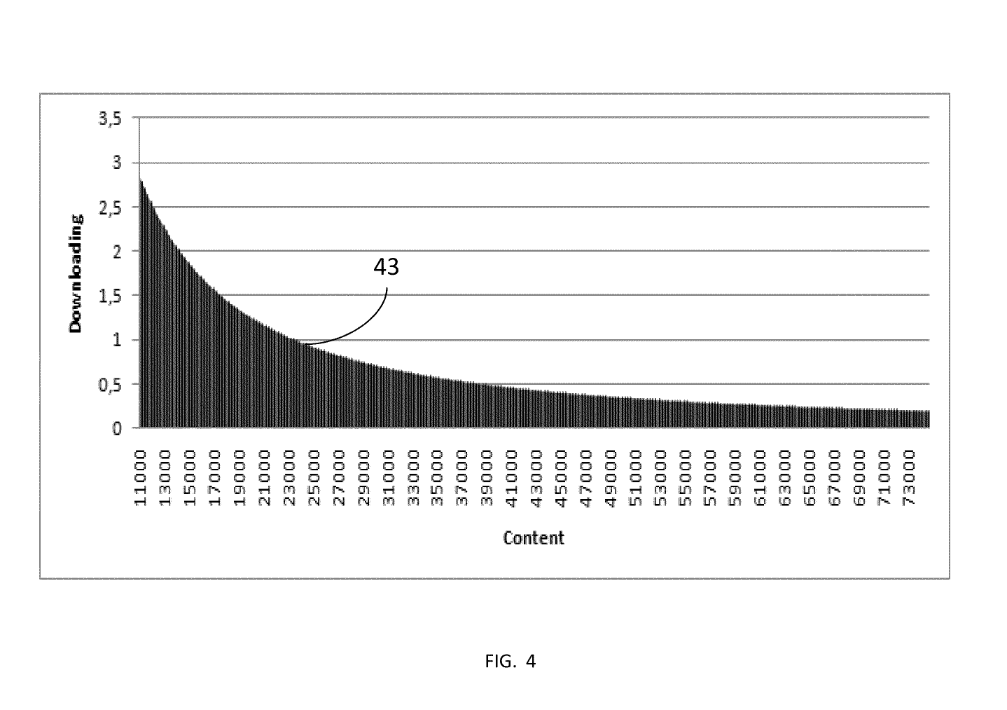

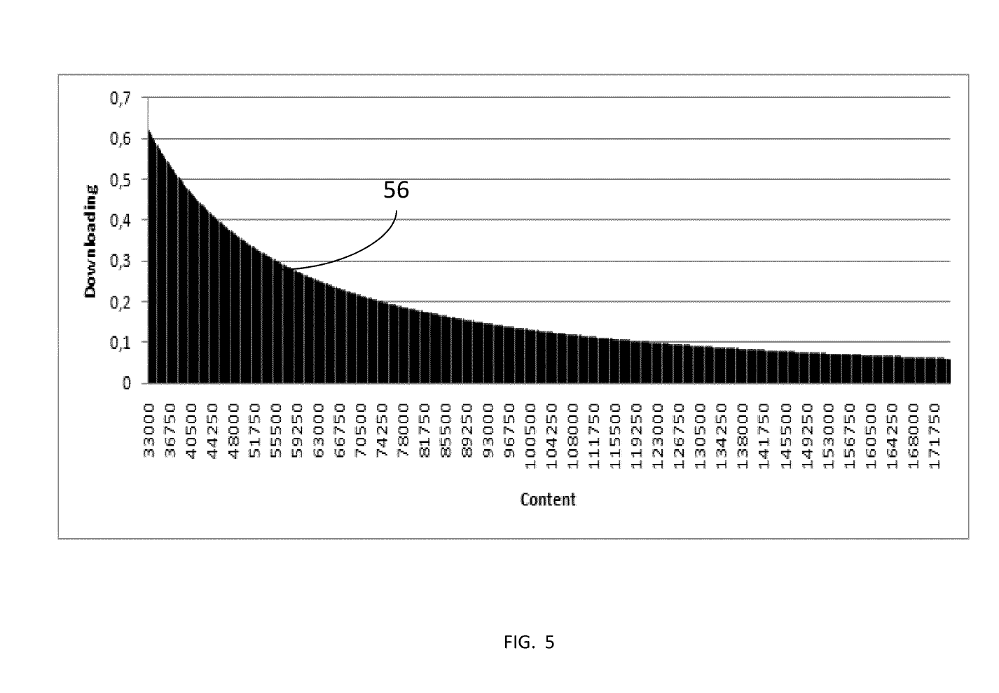

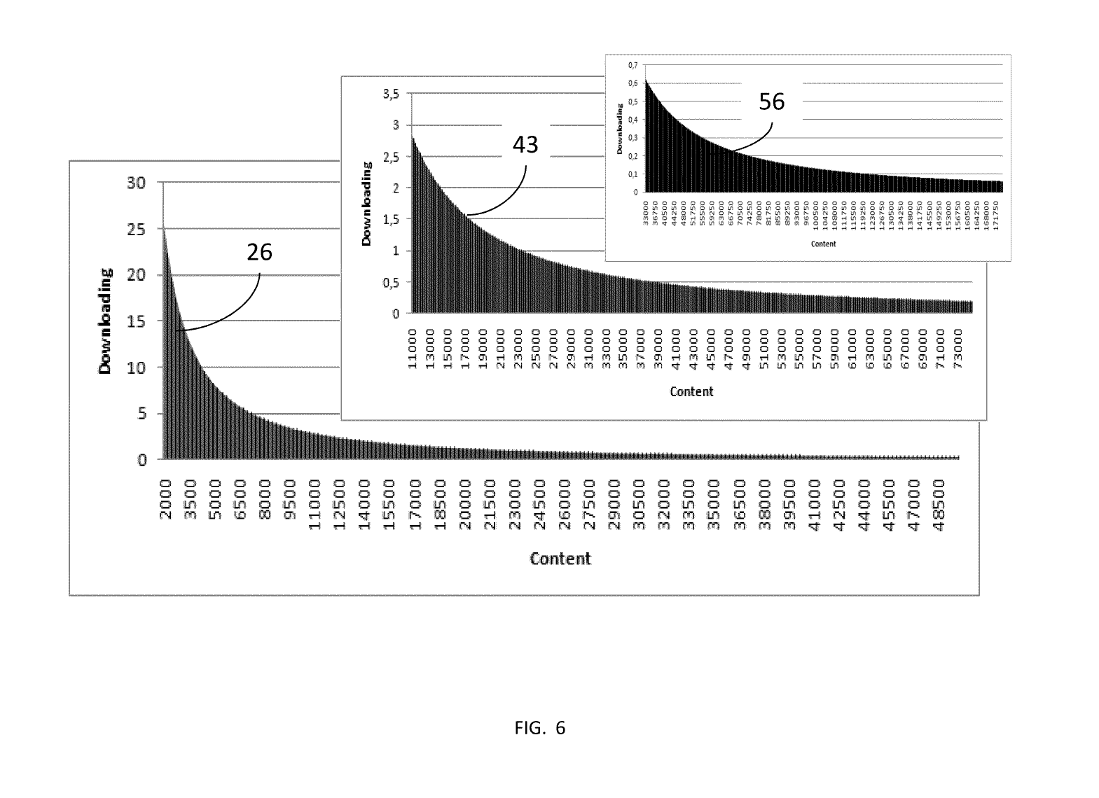

It is well known that every time we approach larger values in the x-axis of the content objects or goods, in an ordered manner with regard to the demand function, we can progressively see the tail of the tail (see FIGS. 3, 4, and 5). FIG. 3 shows a longer portion of tail 26 of FIG. 2 with a smaller scale x-axis. FIG. 4 shows a longer tail portion 43 of FIG. 3 with an even smaller scale x-axis. FIG. 5 shows a longer tail portion 56 of FIG. 4 with yet an even smaller scale x-axis. Note the change in scale size for the y-axis, as well. FIG. 6 shows the curves from FIGS. 3, 4, and 5 together, in order to indicate the relative change of scale in the x and y-axis, consecutively with scales ranging from 2 to 50 thousand in the x-axis and values from 0 to 25 in the y-axis 26 (FIG. 3); from 11 to 75 thousand in the x-axis and values from 0 to 2.75 in the y-axis 43 (FIG. 4); and from 33 to 175 thousand in the x-axis and values from 0 to 0.6 in the y-axis 56 (FIG. 5).

It is important to be able to model these curves correctly. However, the method hereby proposed is not intended to fit existing sales data to a mathematical model—after all, an on-line business already knows their current sales rank and the full demand curve.

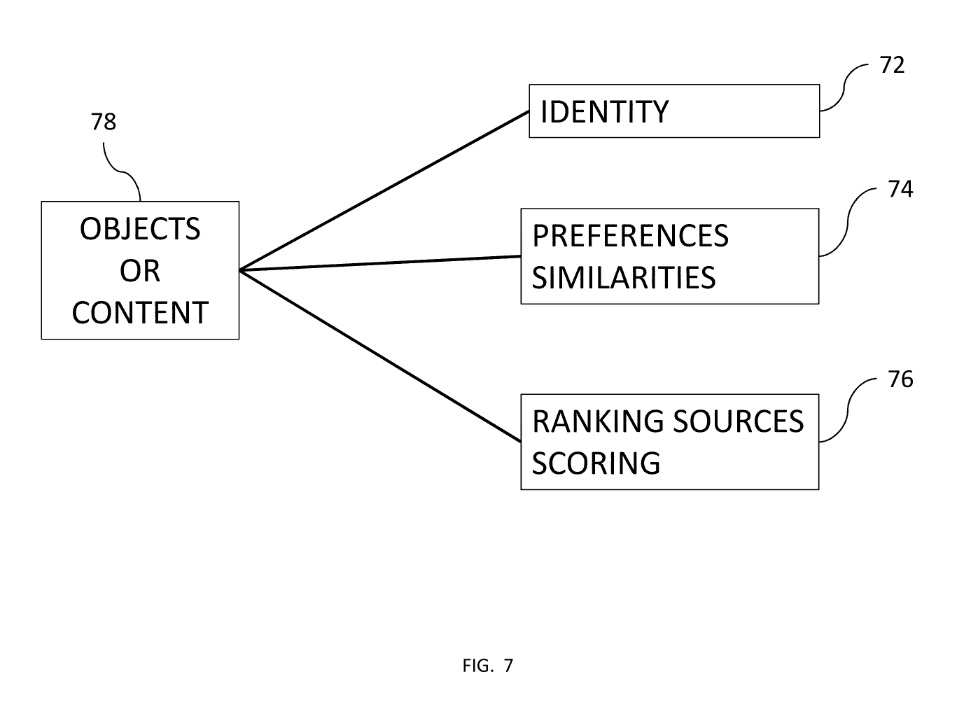

Referring to FIG. 7, the method actually constructs the demand curve for all objects or contents 78 (products, services, etc.), including those for which the ranking score within the full universe is not known yet. All that is required for constructing the demand curve is object identity 72, i.e., the objects in the universe are well defined through a precise identity specification including a set of known preference scores for some of the objects, preference similarities 74, i.e., a quantifiable measure of similarity between all objects of the universe, and ranking sources scoring 76 from which we can generate scores based on preferences calculated by similarity.

The Von Neumann-Morgenstern utility theorem states that if we have a set of decision preferences among the objects of a given set, then there exists a function on these objects that is able to reproduce the preferences. (We can think of this utility function as an absolute ranking function). In the problem described here, we do not have preferences, but the preferences are constructed based on the similarity measure concept. Invented by the Hungarian-born American physicist and chess master Arpad Elo, the Elo method is aimed at the ranking of multiple players based on matches within tournaments engaging two players at a time. The Elo method works by exchanging rating values between each two players according to the results of their match, using a precise formula designed to reproduce a scoring curve with a Gaussian distribution. After a sufficiently large number of tournaments, the emergent distribution of Elo ratings reproduces the distribution that is expected theoretically.

The method described herein also works by iterating successive “tournaments” among objects of similar rank, but the precise mechanism for the interaction (i.e. exchange) of the ratings is now designed to achieve a power-law decay curve rather than the Gaussian distribution mentioned above. Since the domain where this problem first appeared deals with the media industry, we have dubbed this part of the method “MELO tournaments”, as in Media-Elo. In the specific instantiation herein, the methods for identity, preferences, and similarity, as well as scoring, are directed to music and songs as described in U.S. Pat. No. 7,081,579, the entire disclosure of which is incorporated herein by reference. The process herein is applicable for use when constructing the iterative extension to the whole universe of songs. Accordingly, we will call this method Music MELO: MMELO.

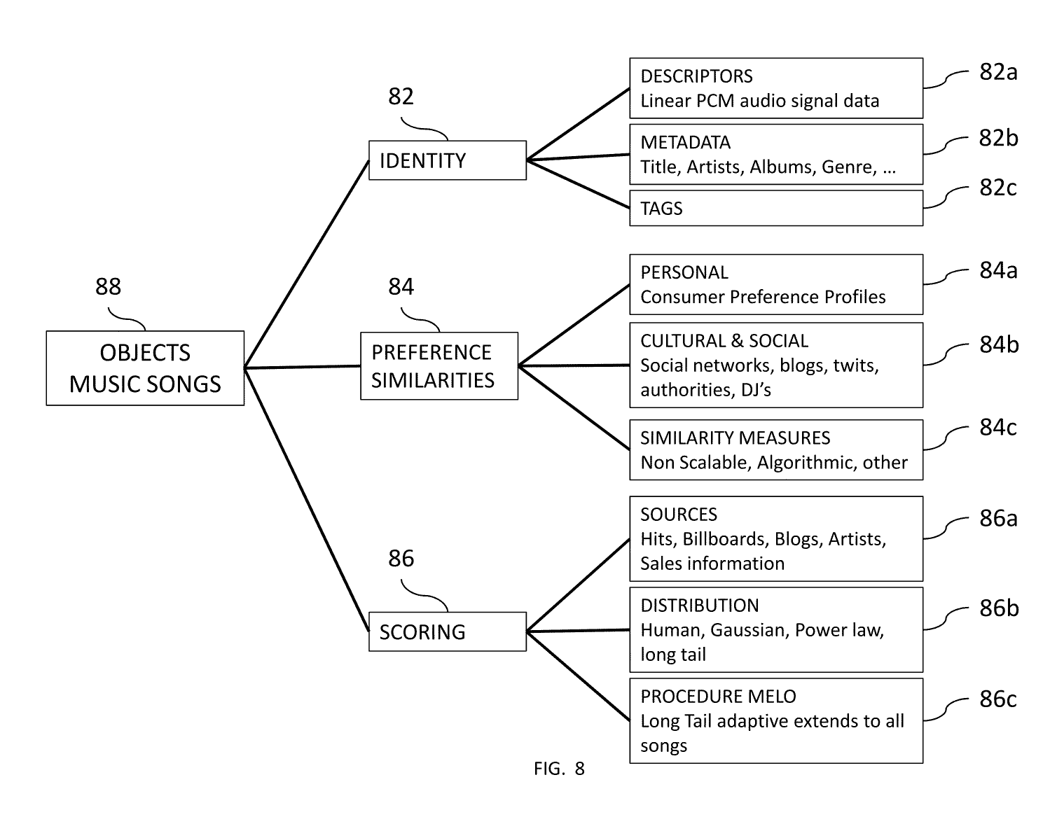

Let us describe now the general procedure adapted to the set of objects being the universe of music songs. As shown in FIG. 8, the specific example for the universe of objects or content 88 on which to create the demand curve is music songs (products: Music songs, downloads, etc.). According to systems and methods herein, the process can be performed on the wide variety in media content that can be found in streaming or downloaded songs. The method described herein produces a long tail scoring curve for any large set of objects, using only these elements: the score value of a few objects, which act as a source of reference values; a quantified measure of similarity between all objects; and the assumption that the scoring must follow a long tail decay as we progress towards the lowest ranked (i.e. a power-law).

First, the songs have a well-defined identity 82 for which it is assumed that the scoring/demand curve will follow a Long Tail law.
a) The songs are very well defined with descriptors 82a intrinsic to the nature of the songs. U.S. Pat. No. 7,081,579 92 describes a process for analyzing music in songs represented by their linear PCM (Pulse Code Modulation). The uncompressed or compressed audio data is divided into a plurality of discrete parts that will allow a quantifiable unique representation of the song on a multidimensional space wherein each coordinate is the unique coefficient on the quantifiable characteristics derived from the audio signal (brightness, bandwidth, tempo, volume, rhythm, low frequency, octave, and many others).
b) Metadata 82b is very well defined in the music industry as it encompasses information such as: Title, Artists, Albums, Genre, and Subgenre, among others.
c) Tags 82c are common in the music industry. There is a common industry standard on audio tagging methods such as formats like ID3 (mostly used with MP3 format), APE, Vorbis used in many media distributors such Windows Media Player, iTunes, and recently Amazon and others. Such tags 82c can delivery metadata from song listening or song incomplete voice descriptors modes ranging from 2 to 20 seconds (Shazam Encore (Shazam Entertainment), SoundHound ∞SoundHound, MusicID with Lyrics (Gravity Mobile), MusicDNA ID (Bach Technology). Many industry recommenders have their own tagging systems.

Next, the score values 86 for a few objects will act as a source of reference for the scores of the rest of the objects.
a) The scores can come from different sources 86a. For example, in this case we will use the knowledge on certain popularity of the song due to its proximity “hits”, as defined in U.S. Pat. No. 7,081,579. Other examples of scoring may include economic factors (sales, downloads, streaming time, etc.).
b) There can be different distributions 86b in the songs. In this case, the universe of songs will be assumed to have a power law or long tail distribution.
c) Different objects can be scored using different scoring procedures 86c as described in detail below, herein adapted to music songs context. Systems and methods herein will treat these few objects with a Long Tail distribution (power law).

The third input is a quantitative scalar measure of preference similarities 84. The similarities defined on all the content set will be used to derive relative preferences among the objects. These preferences are used by the method to re-compute scores in an Elo-like process.
a) Personal preferences 84a can be determined by the methods for capturing personal preferences and music tastes of listeners or users as described in U.S. Pat. No. 7,081,579. Bidimensional graphical projection for optimizing viewing of the constellation of songs to facilitate capturing of user tastes, discovery and delivery of recommendations is described in U.S. Pat. No. 7,982,117 and U.S. Pat. No. 8,053,659, the disclosures of which are incorporated herein by reference.
b) Cultural preferences and/or social preferences 84b can be extracted from network information as contextual enriching information from the vector space of the song universe into the similarity measure.
c) A similarity measure 84c, which in this case will be of an algorithmic nature as described in U.S. Pat. No. 7,081,579, uses the unique measure of similarity based on the audio signals.

According to the method described herein, we will construct a procedure to propagate the known score values of the few elements to all the content population, by means of the Elo-like wide tournament, where the ‘game’ is related to the proximity of the objects through the similarity measure between elements.

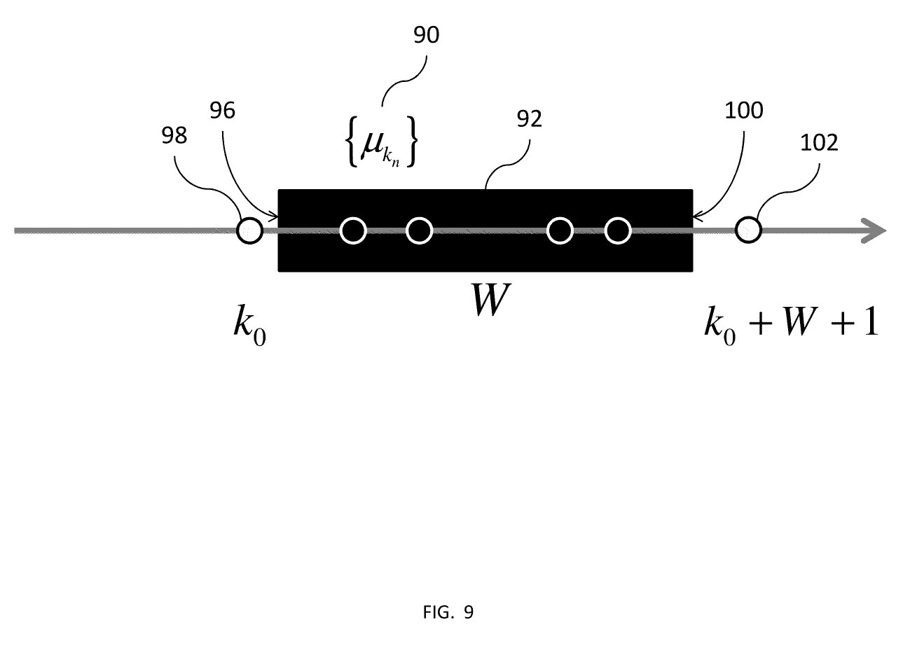

FIGS. 9-14 are used to illustrate the procedure herein. Let us denote the preference score value of element kₙ in our universe as μₖ_{ₙ}. The demand curve is therefore given by the ordered set {μₖ_{ₙ}}_{n=1toN} where μₖ_{ₙ}>μₖ_{ₙ₊₁} for all n=1 to N. This is shown as curve 14 in FIG. 1, where one can see the decreasing ranking values in the y-axis as values increase in the x-axis.

Initialization: all objects kₙ with unknown preference score value for μₖ_{ₙ} are assigned an arbitrary low score (e.g. zero). (Reference objects are assigned their known preference score values.) Without loss of generality, it may be assumed that these are all positive numbers, since, if they were not, we could then translate (using lambda as the absolute value of the least negative score, and translate by this lambda) and possibly scale the scoring (“y” vertical) axis.

Step 1 (FIG. 9)—select a “tournament window”: a window 92 of consecutive objects within the current ordered set {μₖ_{ₙ}} 90 that will participate in the Elo-like tournament. The window 92, having a width W, starts at a location 96 after some point k₀ 98 and ends at a location 100 before some point k₀+W+1 102. As discussed below, both the size W of the window and the selection of the window location are not essential for the method to work. Randomly selected locations for the start of the window 92 after the boundary element k₀ 98, as well as the end of the window 100 before k₀+W+1 102, determined by a fixed value of window width W, yield good results, demonstrating the robustness of the method. According to systems and methods herein, this provides about ten to a thousand objects.

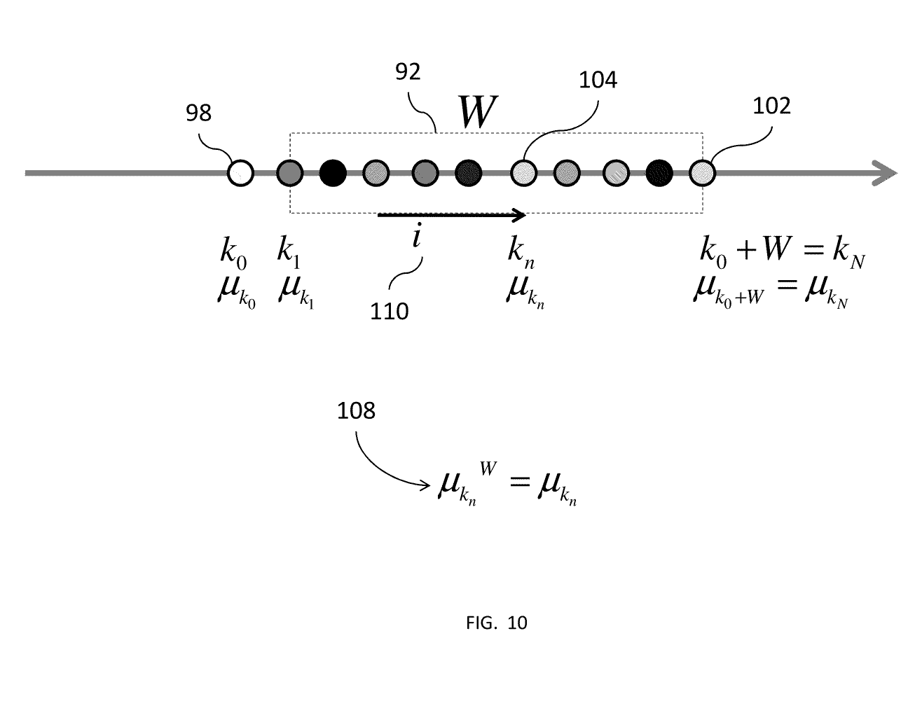

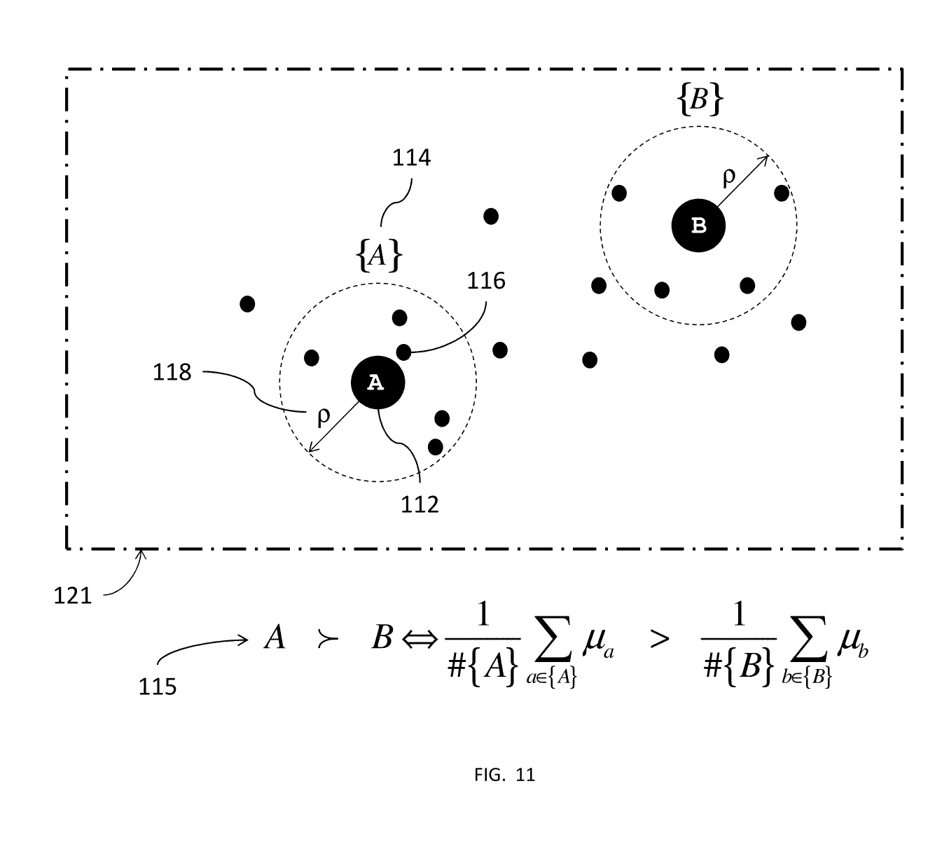

Step 2 (FIG. 10)—use similarities among objects to construct the window 92. Compute the utility-function-like preferences for all items kₙ 104 in the window 92, using the similarity values according to the following averaging procedure:
a) For every item kₙ 104 in the window 92 having a preference μₖ_{ₙ}, compute its temporary preference score μₖ_{ₙ}^{W} 108 as the average value of μₖ_{ₙ} over the object and its nearest neighbors in the universe (see FIG. 11, 121). In other words, for any given object kₙ=A 112 within the window, there will be several neighbor objects 116. Note that the temporary preference score μₖ_{ₙ}^{W} 108 is initially based on the similarity of objects. That is, μₖ_{ₙ}^{W} 108 represents the preference for an object in relation to the window 92.
b) If we denote the set of nearest neighbors of object A by {A} 114, we calculate the preference score

$${μ}_{A}^{W} = \frac{1}{\# \{ A \}} {\sum }_{\{ A \}} {μ}_{A}$$

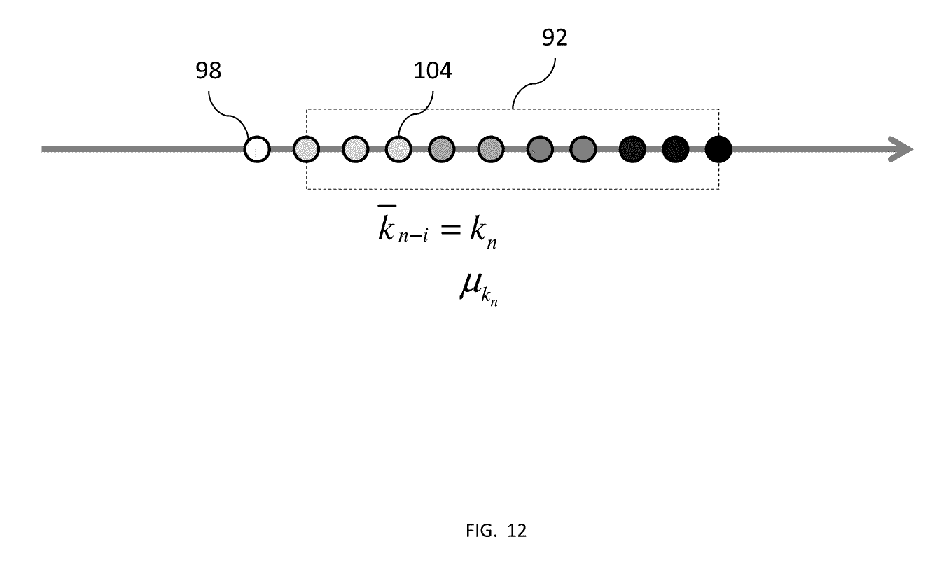

115. The set of nearest neighbor objects 116 to a given object A can be found using an arbitrarily chosen cut-off value ρ 118 for the similarity values that we have for the problem at hand (again, the method is robust against variations in this cut-off value).
c) Then, the temporary preference score μₖ_{ₙ}^{W} 108 is used to reorder the subset {μₖ_{ₙ}}_{n=1toN} 90 within the window 92 from least preferred to most preferred along an increasing value for i 110.
d) This results in the subset {μₖ_{ₙ}}_{n=1toN} shown in FIG. 12 in which the objects kₙ 104 are reordered according to their preference values μₖ_{ₙ}.

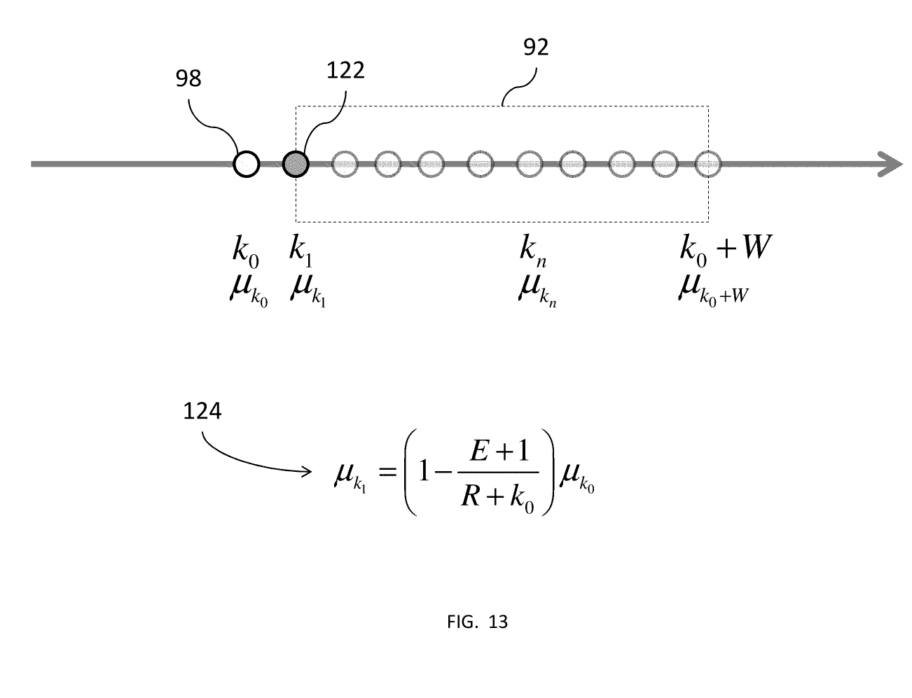

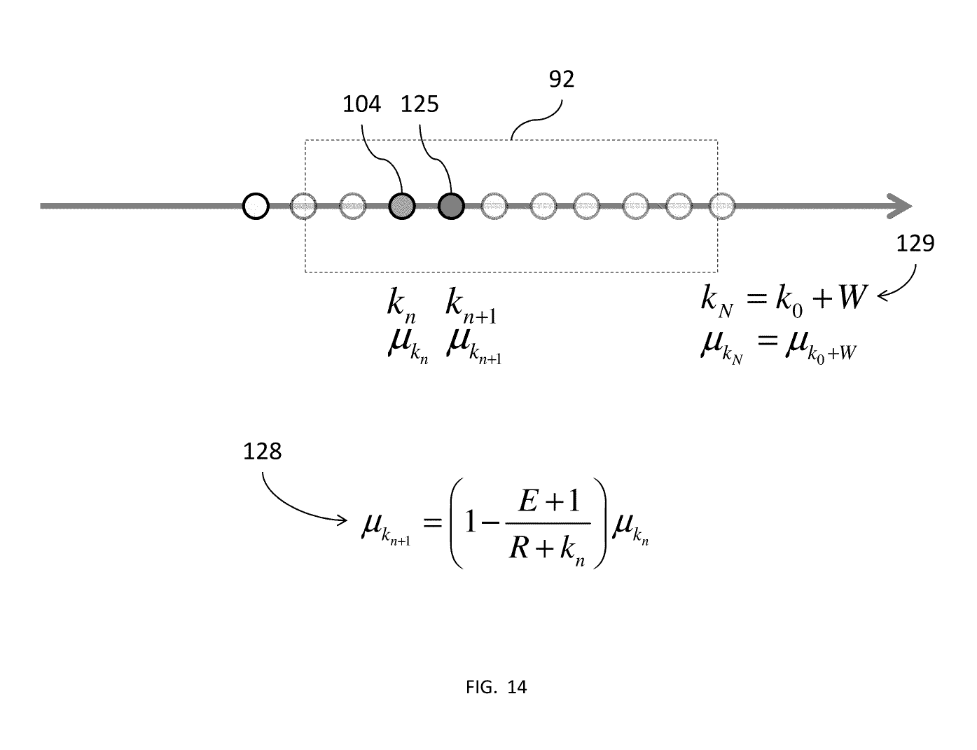

Step 3 (FIGS. 13 and 14)—redefine the score values according to this MMELO procedure, which is designed to achieve convergence and fit the desired distribution of a long tail curve.
a) Given k₀ 98 as a boundary element outside the window 92 with a preference score μₖ_{₀}, begin by assigning a score

$${μ}_{{k}_{1}} = ( 1 + \frac{E + 1}{R + {k}_{0}} ) {μ}_{{k}_{0}}$$

124 to k₁ 122.
b) Then compute the rest of the preference scores in the window recursively from the first element k₁ 122 by making the score at each stage n+1 based on the score calculated at stage n+1; that is, as shown in FIG. 14, for kₙ₊₁ 125 its preference score as a function of the score for μₖ_{ₙ} is defined as

$${μ}_{{k}_{n + 1}} = ( 1 - \frac{E + 1}{R + {k}_{n}} ) {μ}_{{k}_{n}}$$

128 until kₙ=k_{N} or k_{N}=k₀+W 129.
c) The values of E and R are adjusted a posteriori, once the procedure converges. Parameter E is the exponent of the power law, while R governs the rank value of the “x” axis (objects) of the long tail curve.

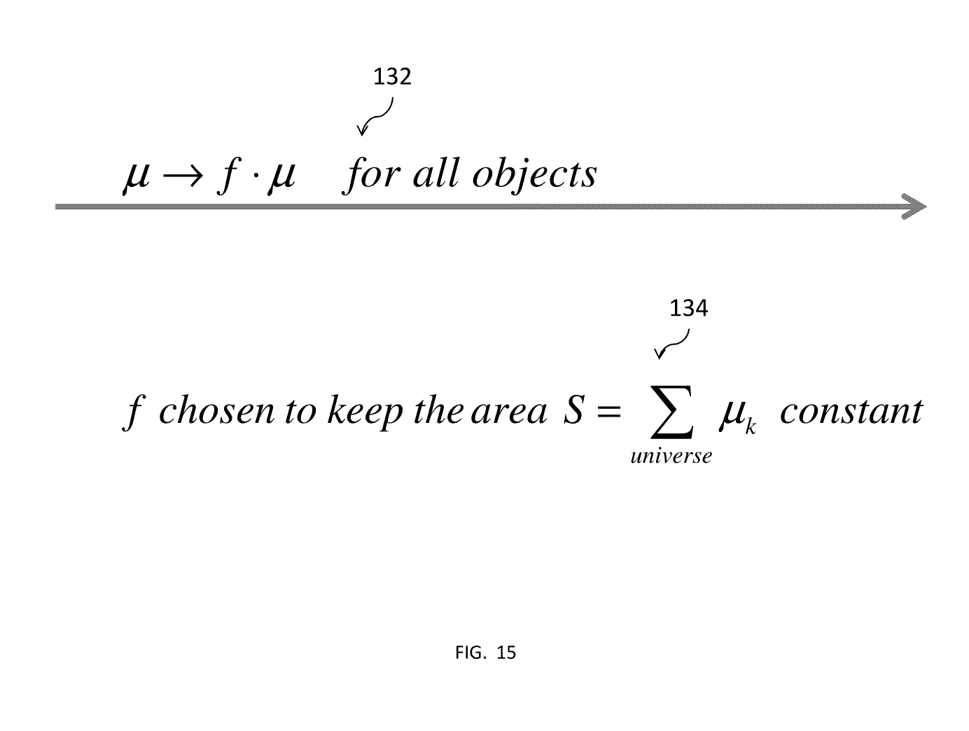

Step 4 (FIG. 15) is a renormalization step: all values in the universe μₖ_{ₙ}→fμₖ_{ₙ} 132 are adjusted using a normalization factor

$$f = \frac{S}{{\sum }_{n = 1 toN} {μ}_{{k}_{n}}}$$

134 designed so as to maintain a constant area or surface S under the curve during the course of the whole procedure.

According to systems and methods herein, the procedure is repeated from step 1 to 4, until convergence in the values {μₖ_{ₙ}} is reached.

This procedure has been found to be robust with respect to small variations in the choice of the size W of the tournament window 92. Larger windows may accelerate the convergence rate of the iterations, but this has to be weighed against the correspondingly larger O(w log w) computational costs due to sorting. Additionally, the convergence is not greatly affected by the particular strategy that is chosen for the location of the windows (index k₀): it is found that a randomly chosen index k₀ works just as well as choosing a back-and-forth sliding window. Similarly, the computation of the temporary preference score μₖ_{ₙ}^{W} 108 within the tournament window (see FIG. 11) is dependent upon some cut-off parameter ρ 118 that needs to be chosen according to the particular typical values that we have available for the similarity values. Again, it is found that the final results are not very sensitive to this cut-off value ρ 118, provided we choose it sensibly: one should use a value big enough so that objects have on average at least a few neighbors, but not so big as to make the full universe 121 their neighbor.

Described herein is a Long Tail Monetization Procedure for music or songs on the Internet, mobile devices, and other commerce platforms. Detailed below is a concrete implementation of the procedure on a two dimensional model, in order to show the feasibility of the industrial application of the systems and methods herein. The process is accomplished on a digital database comprising a plurality of digital song files that have been analyzed to determine musical similarities.

First, consider a geometric two-dimensional model in which the objects under study (our universe) are a set of N randomly chosen songs represented by points (xₖ, yₖ) within a rectangular domain of dimensions Xmax and Ymax. In other words,

0≦xₖ≦Xₘₐₓ

0≦yₖ≦Yₘₐₓ

for k=1, . . . , N. Of course, once we have picked these N songs we will not change them during our procedure, since they are our universe of well-defined objects kₙ (points). The identity of each song is uniquely defined by its two-dimensional coordinates kₙ=(xₖ_{ₙ},yₖ_{ₙ}). Such a universe of music songs is illustrated in U.S. Pat. No. 7,982,117.

We now need to assume a known preference value for the score of some of these songs. We may randomly assign some starting values for the score μ to a fraction of the N songs; these will become our “reference songs” for the final emergent scoring function. According to systems and methods herein, starting preference values may be obtained from economic factors such as sales, downloads, streaming time, etc. One may experiment the whole procedure with varying values of this fraction, as the results are robust with respect to this value. In addition, for the purposes of this disclosure, we will assume that the score values μₖ are positive.

Only one more ingredient is needed now, namely a quantitative measure of similarity between points. For this, as the similarity measure, one could use the Euclidean distance between characteristic vectors for the songs in two dimensions, as described in U.S. Pat. No. 7,081,579.

Again, referring to FIGS. 9-15, we can now start the constructive procedure to compute the preference score curve for our music universe, following these steps:

Initialization: all points kₙ=(xₖ_{ₙ},yₖ_{ₙ}) for a song with an unknown preference score value μₖ_{ₙ} are assigned a preference score of zero, while the reference songs are assigned their known preference score values.

Step 1—select a “tournament window”: a window 92 having consecutive points within the current ordered set {μₖ_{ₙ}} 98 of songs, on which the Elo-like tournament will take place. The window 92 starts at an arbitrary location 96 after some initial point k₀ 98 and ends at a location 100 before some point k₀+W+1 102. k₀ 98 and k₀+W+1 102 represent songs outside the tournament window 92. According to systems and methods herein, the window 92 has a width W. Both the size W of the window and the selection of the window location are not essential for the method to work. Randomly selected locations for the start 96 of the window 92 after k₀ 98, as well as the end 100 of the window 92 before some point k₀+W+1 102, with a fixed value of window width W, provides about ten to a thousand songs and yields good results.

Step 2—compute the utility-function-like preferences for the songs kₙ 104 in the window 92 using the similarity values according to the following averaging procedure:
a) For every song kₙ 104 in the window 92 having a preference score μₖ_{ₙ}, compute its temporary preference score μₖ_{ₙ}^{W} 108 as the average value of μₖ_{ₙ} over the song and its nearest neighbors in the universe (see FIG. 12, 121) based on the similarity measure, which a simple one could be the Euclidean distance between characteristic vectors for each song. The set of nearest neighbors to a given song kₙ=(xₖ_{ₙ},yₖ_{ₙ}) may be found using an arbitrarily chosen cut-off value ρ 118 for the given similarity measure. In this case, this should be a suitable distance in two-dimensional space, so that the neighborhoods are neither too large nor too small considering the boundaries (Xmax, Ymax) where our universe lives.
b) Then, the temporary preference scores μₖ_{ₙ}^{W} 108 may be used to reorder the subset {μₖ_{ₙ}}_{n=1toN} within the window 92 as shown in FIG. 12. According to systems and methods herein, the subset is reordered from least preferred to most preferred along an increasing value for i 110.

Step 3—calculate new score values for the songs according to this MMELO procedure, which is designed to achieve convergence to a long tail curve.
a) We have the first song k₀ 108 as our first boundary element outside the window 92 and its preference score μₖ_{ₙ}. Start with song k₁ 122 by assigning the preference score

$${μ}_{{k}_{1}} = ( 1 + \frac{E + 1}{R + {k}_{0}} ) {μ}_{{k}_{0}}$$

124 (FIG. 13) to song k₁ 122.
b) Then compute the rest of the preference scores for all the songs in the window 92 recursively starting from k₁ by making the preference score of song kₙ₊₁ 125 a function of the preference score of song kₙ 104 using the recursive formula

$${μ}_{{k}_{n + 1}} = ( 1 + \frac{E + 1}{R + {k}_{n}} ) {μ}_{{k}_{n}}$$

128 until the last song in the window, i.e., kₙ=k₀+W (see FIG. 14, 129).
c) The values of E and R are adjusted a posteriori, once the procedure converges. Parameter E is the exponent of the power-law, while R governs the rank value of the “x” axis (songs) of the long tail curve.

Step 4—renormalization: all preference score values in the universe of songs μₖ_{ₙ}→fμₖ_{ₙ} 132 are adjusted using a normalization factor

$$f = \frac{S}{{\sum }_{n = 1 toN} {μ}_{{k}_{n}}}$$

134, designed so as to maintain a constant area or surface S under the curve during the course of the whole procedure.

Repeat the procedure from step 1 to 4, until convergence in the values {μₖ_{ₙ}}_{n=1toN} is reached.

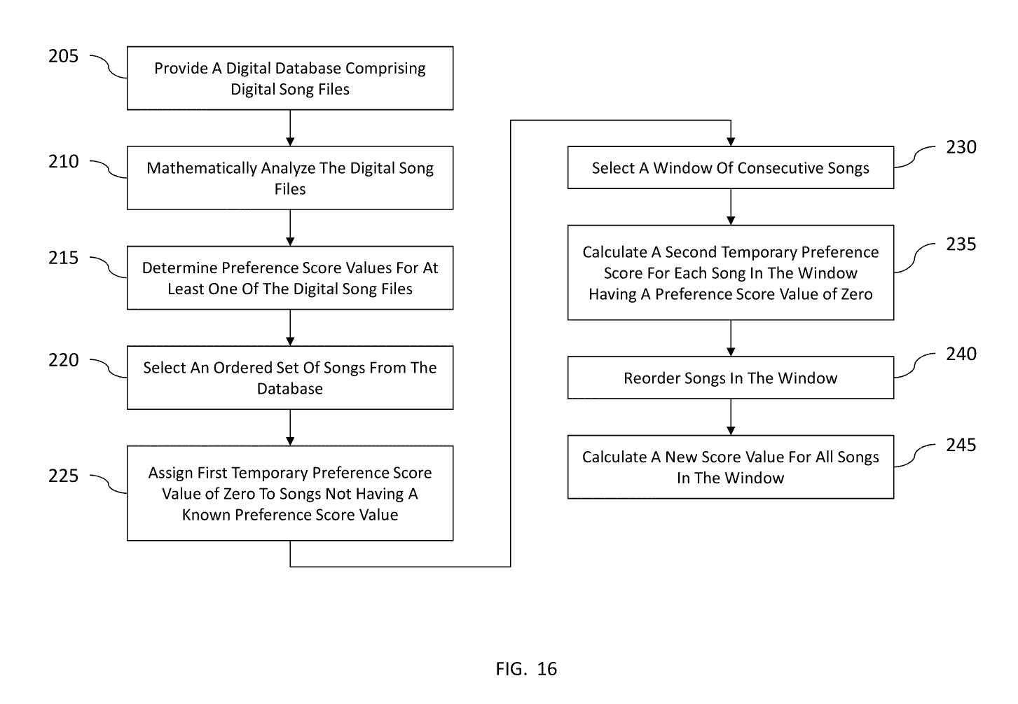

FIG. 16 is a flow diagram illustrating the processing flow of an exemplary method of determining monetization for a long tail demand curve according to systems and methods herein. At 205, a digital database comprising digital song files is provided. The digital song files are mathematically analyzed, at 210. Preference score values for at least one of the digital song files are determined, at 215. At 220, an ordered set of songs is selected from the database. The ordered set of songs includes a set of reference songs each having a corresponding known preference score value and another set of songs each not having a corresponding known preference score value. The known preference score value is based on economic factors comprising one of sales, downloads, and streaming time. A first temporary preference score value of zero is assigned to each song of the another set of songs not having a corresponding known preference score value, at 225. At 230, a window of consecutive songs is selected from the ordered set of songs. The window includes a first subset of reference songs each having the corresponding known preference score value and a second subset of songs each having a corresponding preference score value of zero. At 235, a second temporary preference score is calculated for each song of the second subset of songs in the window, based on its similarity to a nearest song in the first subset of reference songs in order to generate a set of second temporary preference score values. The similarity measure could be based on the Euclidean distance between characteristic vectors for the songs. All songs in the window are reordered based on the set of second temporary preference score values and the known preference score values of the first subset of reference songs, at 240. At 245, a new score value is calculated for all songs in the window, using a power-law exponential equation.

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to a further systems and methods herein, an article of manufacture is provided that includes a tangible computer readable medium having computer readable instructions embodied therein for performing the steps of the computer implemented methods, including, but not limited to, the method illustrated in FIG. 16. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above with reference to FIG. 16.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In case of implementing the systems and methods herein by software and/or firmware, a program constituting the software may be installed into a computer with dedicated hardware, from a storage medium or a network, and the computer is capable of performing various functions if with various programs installed therein.

It is expected that any person skilled in the art can implement the disclosed procedure on a computer, and verify the emergent score curve for various realizations of the parameters in this example model. The generalization of the procedure to real-world scenarios with other definitions for the similarity measure should be evident to any person skilled in the art.

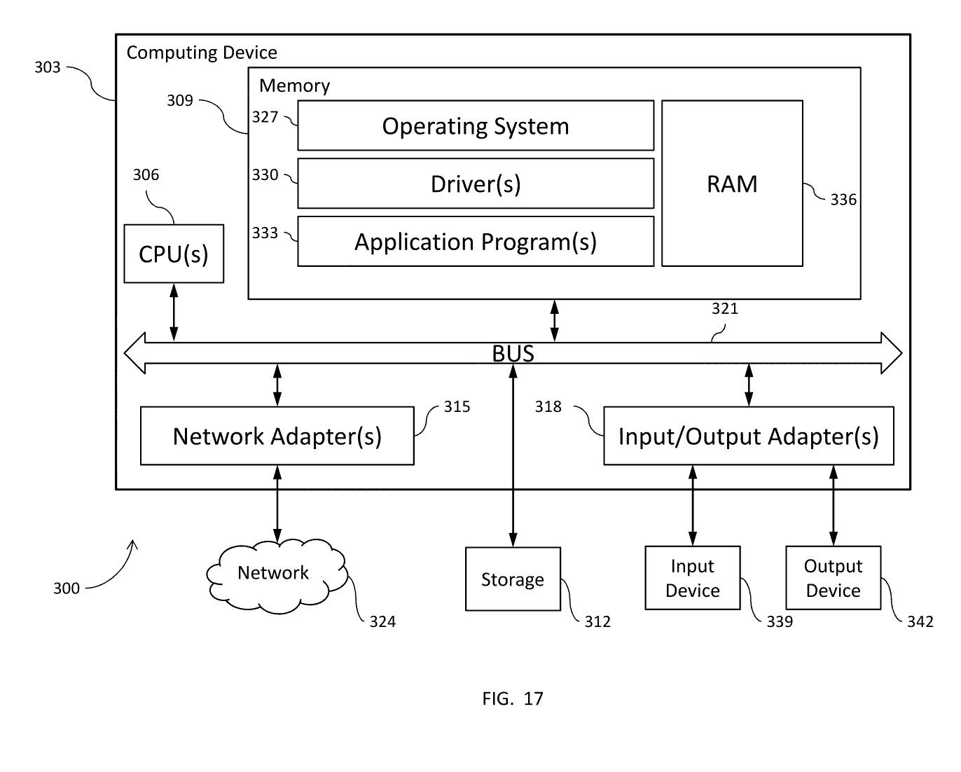

A representative hardware environment for practicing the systems and methods described herein is depicted in FIG. 17. This schematic drawing illustrates a hardware configuration of an information handling/computing system 300 in accordance with systems and methods herein. The computing system 300 comprises a computing device 303 having at least one processor or central processing unit (CPU) 306, internal memory 309, storage 312, one or more network adapters 315, and one or more Input/Output adapters 318. A system bus 321 connects the CPU 306 to various devices such as the internal memory 309, which may comprise Random Access Memory (RAM) and/or Read-Only Memory (ROM), the storage 312, which may comprise magnetic disk drives, optical disk drives, a tape drive, etc., the one or more network adapters 315, and the one or more Input/Output adapters 318. Various structures and/or buffers (not shown) may reside in the internal memory 309 or may be located in a storage unit separate from the internal memory 309.

The one or more network adapters 315 may include a network interface card such as a LAN card, a modem, or the like to connect the system bus 321 to a network 324, such as the Internet. The network 324 may comprise a data processing network. The one or more network adapters 315 perform communication processing via the network 324.

The internal memory 309 stores an appropriate Operating System 327, and may include one or more drivers 330 (e.g., storage drivers or network drivers). The internal memory 309 may also store one or more application programs 333 and include a section of Random Access Memory (RAM) 336. The Operating System 327 controls transmitting and retrieving packets from remote computing devices (e.g., host computers, database storage systems, SCADA, etc.) over the network 324. The driver(s) 330 execute in the internal memory 309 and may include specific commands for the network adapter 315 to communicate over the network 324. Each network adapter 315 or driver 330 may implement logic to process packets, such as a transport protocol layer to process the content of messages included in the packets that are wrapped in a transport layer, such as Transmission Control Protocol (TCP) and/or Internet Protocol (IP).

The storage 312 may comprise an internal storage device or an attached or network accessible storage. Storage 312 may include disk units and tape drives, or other program storage devices that are readable by the system. A removable medium, such as a magnetic disk, an optical disk, a magneto-optical disk, a semiconductor memory, or the like, may be installed on the storage 312, as necessary, so that a computer program read therefrom may be installed into the internal memory 309, as necessary. Programs in the storage 312 may be loaded into the internal memory 309 and executed by the CPU 306. The Operating System 327 can read the instructions on the program storage devices and follow these instructions to execute the methodology herein.

The Input/Output adapter 318 can connect to peripheral devices, such as input device 339 to provide user input to the CPU 306. The input device 339 may include a keyboard, mouse, pen-stylus, microphone, touch sensitive display screen, or any other suitable user interface mechanism to gather user input. An output device 342 can also be connected to the Input/Output adapter 318, and is capable of rendering information transferred from the CPU 306, or other component. The output device 342 may include a display monitor (such as a Cathode Ray Tube (CRT), a Liquid Crystal Display (LCD), or the like), printer, speaker, etc.

The computing system 300 may comprise any suitable computing device 303, such as a mainframe, server, personal computer, workstation, laptop, handheld computer, telephony device, network appliance, virtualization device, storage controller, etc. Any suitable CPU 306 and Operating System 327 may be used. Application Programs 333 and data in the internal memory 309 may be swapped into storage 312 as part of memory management operations.

As will be appreciated by one skilled in the art, aspects of the systems and methods herein may be embodied as a system, method, or computer program product. Accordingly, aspects of the present disclosure may take the form of an entirely hardware system, an entirely software system (including firmware, resident software, micro-code, etc.) or an system combining software and hardware aspects that may all generally be referred to herein as a “circuit,” “module”, or “system.” Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read-Only Memory (ROM), an Erasable Programmable Read-Only Memory (EPROM or Flash memory), an optical fiber, a magnetic storage device, a portable compact disc Read-Only Memory (CD-ROM), an optical storage device, a “plug-and-play” memory device, like a USB flash drive, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various systems and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular systems and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

While particular values, relationships, materials, and steps have been set forth for purposes of describing concepts of the systems and methods herein, it will be appreciated by persons skilled in the art that numerous variations and/or modifications may be made to the systems and methods as shown in the disclosure without departing from the spirit or scope of the basic concepts and operating principles of the concepts as broadly described. It should be recognized that, in the light of the above teachings, those skilled in the art could modify those specifics without departing from the concepts taught herein. Having now fully set forth certain systems and methods, and modifications of the concepts underlying them, various other systems and methods, as well as potential variations and modifications of the systems and methods shown and described herein will obviously occur to those skilled in the art upon becoming familiar with such underlying concept. It is intended to include all such modifications and alternatives insofar as they come within the scope of the appended claims or equivalents thereof. It should be understood, therefore, that the concepts disclosed might be practiced otherwise than as specifically set forth herein. Consequently, the present systems and methods are to be considered in all respects as illustrative and not restrictive.

The corresponding structures, materials, acts, and equivalents of all means or step plus function elements in the claims below are intended to include any structure, material, or act for performing the function in combination with other claimed elements as specifically claimed. The descriptions of the various systems and methods herein have been presented for purposes of illustration, but are not intended to be exhaustive or limited to the systems and methods disclosed. Many modifications and variations will be apparent to those of ordinary skill in the art without departing from the scope and spirit of the described systems and methods. The terminology used herein was chosen to best explain the principles of the systems and methods, the practical application or technical improvement over technologies found in the marketplace, or to enable others of ordinary skill in the art to understand the systems and methods disclosed herein.

What is claimed is:

1. A method comprising:
providing a digital database comprising digital song files;
mathematically analyzing said digital song files, using a computerized device;
determining preference score values for at least one of said digital song files, using said computerized device;
selecting an ordered set of songs from said database, using said computerized device, said ordered set of songs including a set of reference songs each having a corresponding known preference score value and another set of songs each not having a corresponding known preference score value;
assigning a first temporary preference score value of zero to each song of said another set of songs not having a corresponding known preference score value, using said computerized device;
selecting a window of consecutive songs from said ordered set of songs, using said computerized device, said window including a first subset of reference songs each having said corresponding known preference score value and a second subset of songs each having a corresponding preference score value of zero;
calculating a second temporary preference score value for each song of said second subset of songs in said window, based on a measure of similarity to a nearest song in said first subset of reference songs to generate a set of second temporary preference score values, using said computerized device; and
reordering said songs in said window based on said set of second temporary preference score values and said known preference score values of said first subset of reference songs, using said computerized device.

2. The method according to claim 1, said measure of similarity to a nearest song in said window being based on a distance between characteristic vectors for each song, and
said known preference score values being based on economic factors comprising one of sales, downloads, and streaming time.

3. The method according to claim 1, further comprising:
calculating a new score value for each song in said window using a power-law exponential equation, using said computerized device, said calculating being performed by obtaining a score value to a boundary element and recursively calculating said corresponding new score for each song in said window based on said score value of said boundary element and said corresponding second temporary preference score value or said corresponding known preference score value of said song to generate a set of new score values of said window, said boundary element being a song in said ordered set of song outside of said window; and
adjusting all songs in said ordered set of songs based on said set of new score values of said window.

4. The method according to claim 3, said power-law exponential equation comprising:
$${μ}_{{k}_{1}} = ( 1 - \frac{E + 1}{R + {k}_{0}} ) {μ}_{{k}_{0}}$$
where k₀ comprises said boundary element outside said window,
μₖ_{₀} comprises said score value for said boundary element k₀,
E comprises an exponent of said power-law, and
R governs a rank value of songs along a long tail demand curve.

5. The method according to claim 4, further comprising:
calculating said corresponding new score value for each song in said window starting from element k₁ using a recursive formula
$${μ}_{{k}_{n + 1}} = ( 1 + \frac{E + 1}{R + {k}_{n}} ) {μ}_{{k}_{n}}$$
until kₙ=k₀+W, using said computerized device,
where k₀ comprises said boundary element outside said window,
k₁ comprises a first element in said window,
kₙ comprises a next element in said window,
W comprises a number of elements in said window,
μₖ_{ₙ} comprises said corresponding preference score value for element kₙ,
μₖ_{ₙ₊₁} comprises said corresponding preference score value for element kₙ₊₁,
E comprises an exponent of said power-law, and
R governs a rank value of songs along said long tail demand curve.

6. The method according to claim 3, further comprising:
normalizing said corresponding new score value for said songs in said window, using said computerized device, said normalizing comprising using a normalization factor designed to maintain a constant area under a long tail demand curve.

7. The method according to claim 6, said normalization factor comprising:
$$f = \frac{S}{{\sum }_{n = 1 toN} {μ}_{{k}_{n}}}$$
where f comprises said normalization factor,
μₖ_{ₙ} comprises said corresponding preference score for each element kₙ in said window,
S comprises said area under said long tail demand curve, and
N comprises a number of songs in said window.

8. The method according to claim 1, said calculating said second temporary preference score comprising using an equation
$${μ}_{A}^{W} = \frac{1}{\# \{ A \}} {\sum }_{\{ A \}} {μ}_{A}$$
where μ_{A}^{W} comprises said second temporary preference score in said window,
{A} comprises a set of songs within a specified similarity distance from a song A in said window,
μ_{A} comprises said corresponding known preference score value for song A in said window, and
#{A} comprises a number of songs in said set {A}.

9. A computer implemented method of determining monetization for a long tail demand curve, said method comprising:
providing a demand curve comprising an ordered set of songs, each song in said ordered set having a defined identity, said ordered set of songs including a set of reference songs each having a corresponding known preference score value and another set of songs each not having a corresponding known preference score value, using a computerized device;
selecting a first window of consecutive songs from said ordered set of songs, using said computerized device, said first window including a first subset of reference songs each having said corresponding known preference score value and a second subset of songs each not having a corresponding preference score value, said known preference score value being based on economic factors comprising one of sales, downloads, and streaming time;
calculating a temporary preference score value for each song of said second subset of songs in said first window, based on a measure of similarity to a nearest song in said first subset of reference songs to generate a set of temporary preference score values, using said computerized device, said measure of similarity being based on a distance between characteristic vectors for each song;
reordering all songs in said first window based on said set of temporary preference score values and said known preference score values of said first subset of reference songs, using said computerized device; and
calculating a new score value for each song in said first window, using a power-law exponential equation, using said computerized device, said calculating being performed by obtaining a score value to a boundary element and recursively calculating said corresponding new score for each song in said first window based on said score value of said boundary element and said corresponding temporary preference score value or said corresponding known preference score value of said song to generate a set of new score values of said first window, said boundary element being a song in said ordered set of songs outside of said first window.

10. The computer implemented method according to claim 9, further comprising:
selecting a second window of consecutive songs from said ordered set of songs, using said computerized device, said second window including a first subset of reference songs each having a corresponding known preference score value and a second subset of songs each not having a corresponding known preference score value, said known preference score value being based on economic factors comprising one of sales, downloads, and streaming time, said second window overlapping a portion of said first window;
calculating a temporary preference score for each song in said second subset of objects in said second window, based on similarity to a nearest song of said first subset of reference objects to generate a set of temporary preference score values, using said computerized device;
reordering said songs in said second window based on said set of second temporary preference score values and said known preference score values of said first subset of reference songs, using said computerized device; and
calculating a new score value for said songs in said second window, using a power-law exponential equation, using said computerized device, said calculating being performed by obtaining a score value to a boundary element and recursively calculating said corresponding new score for each song in said second window based on said score value of said boundary element and said corresponding second temporary preference score value or said corresponding known preference score value of said song to generate a set of new score values, of said second window, said boundary element being a song in said ordered set of songs outside of said second window.

11. The computer implemented method according to claim 10, further comprising:
determining a third window comprising songs from said first window and said second window, using said computerized device; and
ordering said songs in said third window based on said new score value for said songs in said first window and said second window, using said computerized device.

12. The computer implemented method according to claim 11, said power-law exponential equation comprising:
$${μ}_{{k}_{1}} = ( 1 - \frac{E + 1}{R + {k}_{0}} ) {μ}_{{k}_{0}}$$
where k₀ comprises a boundary element outside said third window,
μₖ_{₀} comprises said corresponding known preference score value for said boundary element k₀,
E comprises an exponent of said power-law, and
R governs a rank value of songs along said long tail demand curve.

13. The computer implemented method according to claim 11, further comprising:
calculating said new score value for each song in said third window starting from element k₁ using a recursive formula
$${μ}_{{k}_{n + 1}} = ( 1 + \frac{E + 1}{R + {k}_{n}} ) {μ}_{{k}_{n}}$$
until kₙ=k₀+W, using said computerized device
where k₀ comprises a boundary element outside said first window,
k₁ comprises a first element in said third window,
kₙ comprises a next element in said third window,
W comprises a number of elements in said third window,
μₖ_{ₙ} comprises said corresponding preference score value for element kₙ,
μₖ_{ₙ₊₁} comprises said corresponding preference score value for element kₙ₊₁,
E comprises an exponent of said power-law, and
R governs a rank value of songs along said long tail demand curve.

14. The computer implemented method according to claim 11, further comprising:
normalizing said corresponding new score value and said temporary preference score for said songs in said third window, using said computerized device, said normalizing comprising using a normalization factor designed to maintain a constant area under said long tail demand curve.

15. The computer implemented method according to claim 14, said normalization factor comprising:
$$f = \frac{S}{{\sum }_{n = 1 toN} {μ}_{{k}_{n}}}$$
where f comprises said normalization factor,
μₖ_{ₙ} comprises said corresponding preference score value for each element kₙ in said third window,
S comprises said area under said long tail demand curve, and
N comprises a number of songs in said third window.

16. The computer implemented method according to claim 11, said calculating said corresponding first temporary preference score comprising using an equation
$${μ}_{A}^{W} = \frac{1}{\# \{ A \}} {\sum }_{\{ A \}} {μ}_{A}$$
where μ_{A}^{W} comprises said corresponding first temporary preference score in said third window,
{A} comprises a set of songs within a specified distance from a song A in said third window,
μ_{A} comprises said corresponding known preference score value for element A in said third window, and
#{A} comprises a number of songs in said set {A}.

17. A system comprising:
a digital database comprising digital song files;
a processor operatively connected to said digital database; and
a memory operatively connected to said processor,
said processor mathematically analyzing said digital song files and determining characteristic vectors for songs in said digital song files,
said processor selecting an ordered set of songs from said database, said ordered set of songs including a set of reference songs each having a corresponding known preference score value and another set of songs each not having a corresponding known preference score value, said known preference score value being based on economic factors comprising one of sales, downloads, and streaming time,
said processor assigning a first temporary preference score value of zero to each song of said another set of songs not having a corresponding known preference score value,
said processor selecting a window of consecutive songs from said ordered set of songs, said window including a first subset of reference songs each having said corresponding known preference score value and a second subset of songs each having a corresponding preference score value of zero,
said processor calculating a second temporary preference score value for each song of said second subset of songs in said window, based on a measure of similarity to a nearest song in said first subset of reference songs to generate a set of second temporary preference score values, said measure of similarity being based on a distance between said characteristic vectors for each song,
said processor storing said second temporary preference score value in said memory, and
said processor reordering said songs in said window based on said set of second temporary preference score values and said known preference score values of said first subset of reference songs.

18. The system according to claim 17, further comprising:
said processor calculating a new score value for said songs in said window, using a power-law exponential equation, said calculating being performed by obtaining a score value to a boundary element and recursively calculating said corresponding new score for each song in said window based on said score value of said boundary element and said corresponding second temporary preference score value or said corresponding known preference score value of said song to generate a set of new score values of said window, said boundary element being a song in said ordered set of song outside of said window.

19. The system according to claim 18, further comprising:
said processor normalizing said new score value for said songs in said window, said normalizing comprising using a normalization factor designed to maintain a constant area under a long tail demand curve.

20. The system according to claim 19, further comprising:
said processor adjusting all songs in said ordered set of songs based on said set of new score values of said window.
